(19) United States
(12) Patent Application Publication
(10) Pub. No.: US 2009/0152316 A1
(43) Pub. Date: Jun. 18, 2009

(54) SELECTABLE FIRING MODE WITH ELECTROMECHANICAL LOCKOUT FOR COMBUSTION-POWERED FASTENER -DRIVING TOOL

(76) Inventor: Larry M. Moeller, Schaumburg, IL (US)

Correspondence Address: GREER, BURNS & CRAIN, LTD., 300 S. WACKER DRIVE, SUITE 2500, CHICAGO, IL, 60606, US

(21) Appl. No.: 12/094,064

(22) PCT Filed: Nov. 17, 2006
(86) PCT No.: PCT/US06/44800

§ 371 Date: Sep. 22, 2008

Related U.S. Application Data
(60) Provisional application No. 60/737,726, filed on Nov. 17, 2005.

(51) Int. Cl. B25C 1/08; B25C 1/14

(52) U.S. Cl. 227/8; 227/10

(57) ABSTRACT

A combustion-powered fastener-driving tool includes a power source including a cylinder and a valve sleeve reciprocating relative to the cylinder between a closed position defining and closing a combustion chamber, and an open position allowing venting of the combustion chamber. A lockout device is associated with the power source and is configured for releasably restraining the valve sleeve in the closed position. A control system is connected to the power source, is operable in both a sequential firing mode and a repetitive firing mode, and is configured for activating the lockout device in a first format when in the sequential firing mode, and in a second format when in the repetitive firing mode.

### RELATED APPLICATION

This application claims priority pursuant to 35 USC § 120 based on U.S. Ser. No. 60/737,726 filed Nov. 17, 2005.

### TECHNICAL FIELD

The present invention relates generally to fastener-driving tools used to drive fasteners into workpieces, and specifically to combustion-powered fastener-driving tools, also referred to as combustion tools or combustion nailers.

### BACKGROUND ART

Combustion-powered tools are known in the art, and exemplary tools produced by Illinois Tool Works of Glenview, Ill., also known as IMPULSE® brand tools for use in driving fasteners into workpieces, are described in commonly assigned patents to Nikolich U.S. Pat. Re. No. 32,452, and U.S. Pat. Nos. 4,522,162; 4,483,473; 4,483,474; 4,403,722; 5,197,646; 5,263,439; 5,897,043 and 6,145,724 all of which are incorporated by reference herein.

Such tools incorporate a tool housing enclosing a small internal combustion engine. The engine is powered by a canister of pressurized fuel gas, also called a fuel cell. A battery-powered electronic power distribution unit produces a spark for ignition, and a fan located in a combustion chamber provides for both an efficient combustion within the chamber, while facilitating processes ancillary to the combustion operation of the device. Such ancillary processes include: mixing the fuel and air within the chamber, turbulence to increase the combustion process, scavenging combustion by-products with fresh air, and cooling the engine. The engine includes a reciprocating piston with an elongated, rigid driver blade disposed within a single cylinder body.

A valve sleeve is axially reciprocable about the cylinder and, through a linkage, moves to close the combustion chamber when a work contact element at the end of the linkage is pressed against a workpiece. This pressing action also triggers a fuel-metering valve to introduce a specified volume of fuel into the closed combustion chamber. Thus, the valve sleeve opens the combustion chamber for venting gases, and closes the combustion chamber for sealing prior to ignition.

It is known to employ a lockout device for controlling the duration of the valve sleeve closed position for enhancing piston return to a prefiring position. Such a lockout device can be employed whether the tool is set for sequential or repetitive firing modes.

Combustion-powered tools now offered on the market are sequentially operated tools. The tool must be pressed against the work, collapsing the workpiece contact element (WCE) before the trigger is pulled for the tool to fire a nail. This contrasts with tools which can be fired repetitively, also known as repetitive cycle operation. In other words, the latter tools will fire repeatedly by pressing the tool against the workpiece if the trigger is held in the depressed mode. These differences manifest themselves in the number of fasteners that can be fired per second for each style tool. The repetitive cycle mode is substantially faster than the sequential fire mode; up to 5 fasteners can be fired per second in repetitive cycle as compared to up to 3 fasteners per second in sequential mode.

One distinguishing feature that limits combustion-powered tools to sequential operation is the manner in which the drive piston is returned to the initial position after the tool is fired. Combustion-powered tools utilize self-generative vacuum to perform the piston return function. Piston return of the vacuum-type requires significantly more time than that of pneumatic tools that use positive air pressure from the supply line for piston return.

With combustion-powered tools of the type disclosed in the patents incorporated by reference above, by firing rate and control of the valve sleeve, the operator controls the time interval provided for the vacuum-type piston return. The formation of the vacuum occurs following the combustion of the mixture and the exhausting of the high-pressure burnt gases. With residual high temperature gases in the tool, the surrounding lower temperature aluminum components cool and collapse the gases, thereby creating a vacuum. In many cases, such as in trim applications, the tool operating cycle rate is slow enough that vacuum return works consistently and reliably.

However, for those cases where a tool is operated at a much higher cycle rate, the operator can open the combustion chamber during the piston return cycle by removing the tool from the workpiece. This causes the vacuum to be lost and piston travel will stop before reaching the top of the cylinder. This leaves the driver blade in the guide channel of the nose, thereby preventing the nail strip from advancing. The net result is no nail in the firing channel and no nail fired in the next shot.

Known combustion nailer control systems include a control module optionally including a microprocessor, an electromechanical lockout device and at least one control switch. One switch is operable by the trigger, and the other is operable by the valve sleeve. The latter provides valve sleeve position information to the control module. Regardless of whether the tool is operating in the sequential or repetitive modes, the lockout control device is typically initiated at the onset of the ignition event to hold the valve sleeve closed and thus facilitate piston return. Thereafter, a timer circuit manages the holding duration of the lockout device.

However, tests have shown that in repetitive firing operation, the users' rapid manipulation of the tool can cause the valve sleeve and the lockout control device to not be properly positioned and therefore not engaged at the time of ignition. If such misengagement occurs, the combustion chamber may open prematurely during the cycle, interfering with piston return and other operational sequences.

Thus, there is a need for an improved combustion nailer control program designed to prevent the above-listed malfunctions.

### DISCLOSURE OF INVENTION

The above-listed needs are met or exceeded by the present combustion-powered fastener-driving tool featuring a selectable firing mode with electromechanical lockout control device, in which the lockout control device is initiated under different circumstances depending on the firing mode (sequential or repetitive firing) of the nailer. In sequential operation, the lockout control device is initiated preferably when the trigger is pulled, or alternatively during the initiation of the ignition cycle. In the repetitive firing mode, the preferred initiation of the lockout control device is when the chamber switch is made. This increases the likelihood that the lockout control device and the valve sleeve, or other linking member, are in position during energizing.

More specifically, a combustion-powered fastener-driving tool includes a power source including a cylinder and a valve sleeve reciprocating relative to the cylinder between a closed position defining and closing a combustion chamber, and an open position allowing venting of the combustion chamber. A lockout device is associated with the power source and is configured for releasably restraining the valve sleeve in the closed position. A control program is connected to the power source, is operable in both a sequential firing mode and a repetitive firing mode, and is configured for activating the lockout device in a first format when in the sequential firing mode, and in a second format when in the repetitive firing mode.

In another embodiment, a combustion-powered fastener-driving tool includes a power source including a cylinder and a valve sleeve reciprocating relative to the cylinder between a closed position defining and closing a combustion chamber, and an open position allowing venting of the combustion chamber, a piston with a driver blade reciprocating in the cylinder, a spark generator for initiating ignition of gas in the combustion chamber for driving the piston in the cylinder. A chamber switch is associated with the power source and is closed when the valve sleeve is positioned to create a closed combustion chamber. A lockout device is associated with the power source and is configured for releasably restraining the valve sleeve in the closed position. A control program is connected to the power source, is operable in both a sequential firing mode and a repetitive firing mode, and is configured for activating the lockout device upon activation of the spark generator when in said sequential firing mode, and upon closing of said chamber switch when in said repetitive firing mode.

### BRIEF DESCRIPTION OF DRAWINGS

FIG. 1 is a front perspective view of a fastener-driving tool incorporating the present control program;

FIG. 2 is a fragmentary vertical cross-section of the tool of FIG. 1 shown in the rest position;

FIG. 3 is a fragmentary vertical cross-section of the tool of FIG. 2 shown in the pre-firing position;

FIG. 4 is a timing chart of the present control program in the sequential firing mode;

FIG. 5 is a timing chart of the present control program in the repetitive firing mode;

FIG. 6 is a timing chart of an alternate control program in the sequential firing mode from that described in FIG. 4;

FIG. 7 is a timing chart of an alternate control program in the repetitive firing mode from that described in FIG. 5; and

FIG. 8 is a timing chart of another alternate control program in the sequential firing mode from that described in FIG. 4.

### BEST MODE FOR CARRYING OUT THE INVENTION

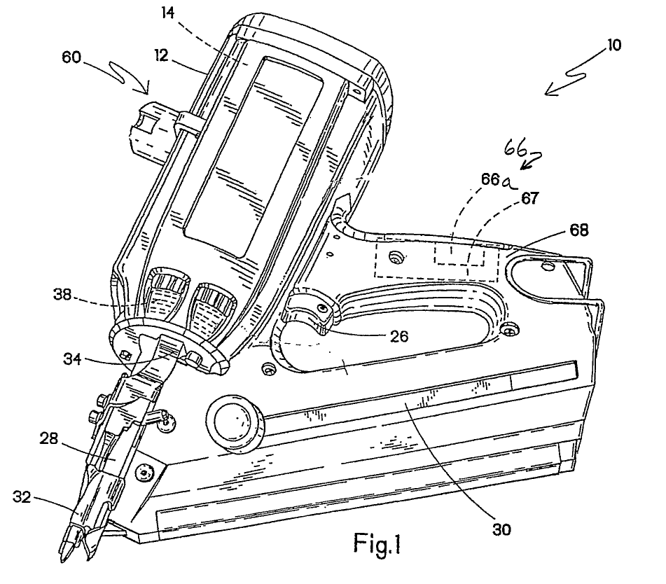

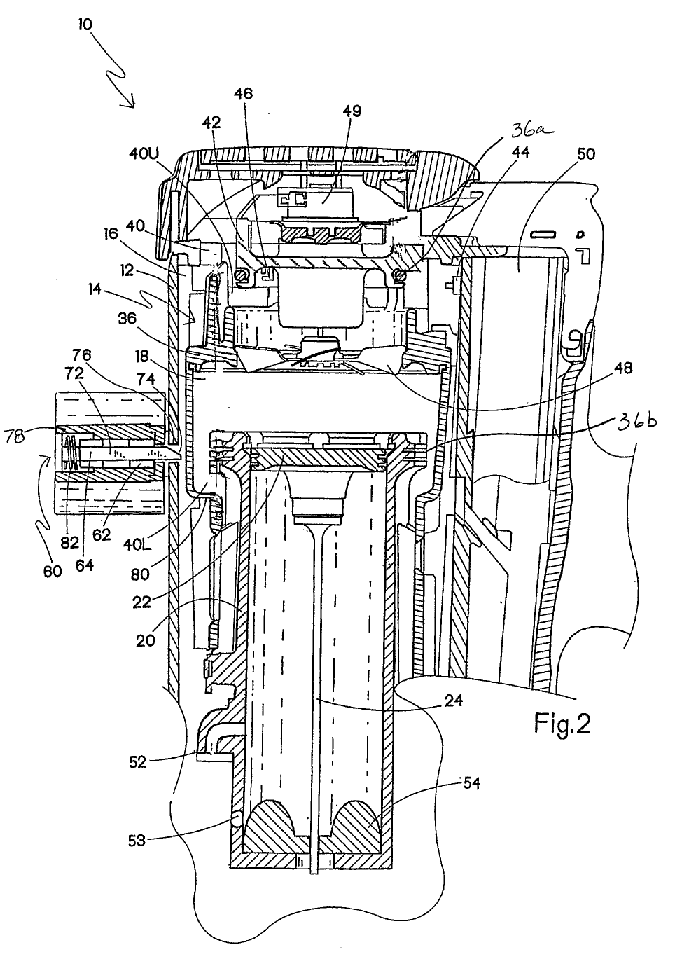

Referring now to FIGS. 1-3, a combustion-powered fastener-driving tool incorporating the present invention is generally designated 10 and preferably is of the general type described in detail in the patents listed above and incorporated by reference in the present application. A housing 12 of the tool 10 encloses a self-contained internal power source 14 within a housing main chamber 16. As in conventional combustion tools, the power source 14 is powered by internal combustion and includes a combustion chamber 18 that communicates with a cylinder 20. A piston 22 reciprocally disposed within the cylinder 20 is connected to the upper end of a driver blade 24. As shown in FIG. 2, an upper limit of the reciprocal travel of the piston 22 is referred to as a pre-firing position, which occurs just prior to firing, or the ignition of the combustion gases which initiates the downward driving of the driver blade 24 to impact a fastener (not shown) to drive it into a workpiece.

When the tool is in a sequential operating mode, through depression of a trigger 26, which inherently closes a trigger switch (not shown, the terms trigger and trigger switch are used interchangeably) an operator induces combustion within the combustion chamber 18, causing the driver blade 24 to be forcefully driven downward into a nosepiece 28. The nosepiece 28 guides the driver blade 24 to strike a fastener that had been delivered into the nosepiece via a fastener magazine 30.

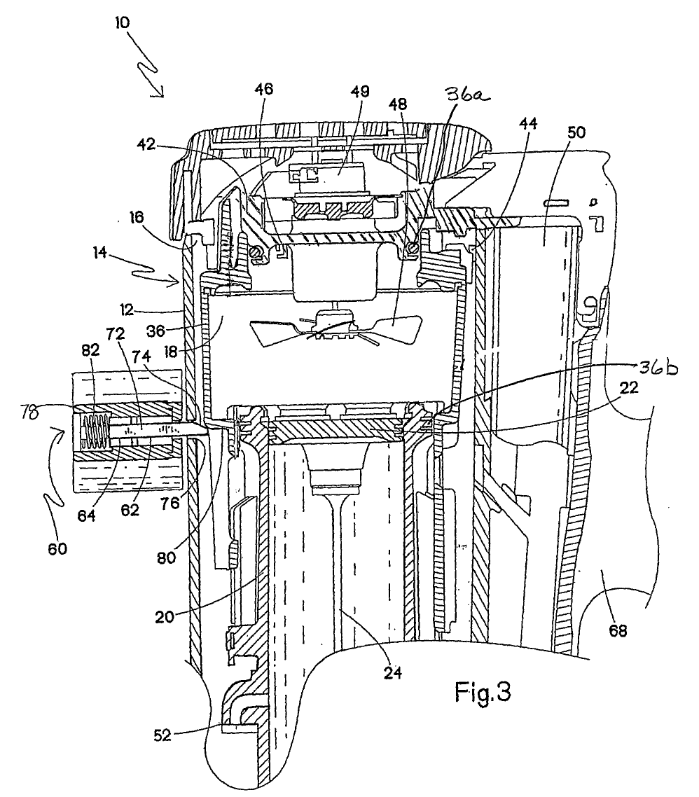

Included in the nosepiece 28 is a workpiece contact element 32, which is connected, through a linkage or upper probe 34 to a reciprocating valve sleeve 36, which partially defines the combustion chamber 18. Depression of the tool housing 12 against a workpiece causes the workpiece contact element 32 to move relative to the tool housing 12, from a rest position (FIG. 2) to a pre-firing position (FIG. 3). This movement overcomes the normally downward biased orientation of the workpiece contact element 32 caused by a spring 38 (shown hidden in FIG. 1).

In the rest position (FIG. 2), the combustion chamber 18 is not sealed, since there is an annular gap 40 separating the valve sleeve 36 and a cylinder head 42, which accommodates a chamber switch or head switch 44 and a spark plug or other spark generator 46. Specifically, there is an upper gap 40U near the cylinder head 42, and a lower gap 40L near the upper end of the cylinder 20. In the preferred embodiment of the present tool 10, the cylinder head 42 also is the mounting point for a cooling fan 48 and a fan motor 49 powering the cooling fan. The fan 48 and at least a portion of the motor 49 extend into the combustion chamber 18 as is known in the art and described in the patents which have been incorporated by reference above. In the pre-firing position (FIG. 3), the combustion chamber 18 is sealed, and is defined by the piston 22, the valve sleeve 36 and the cylinder head 42.

In the sequential operating mode, firing is enabled when an operator presses the workpiece contact element 32 against a workpiece. This action overcomes the biasing force of the spring 38, causes the valve sleeve 36 to move upward relative to the housing 12, and sealing the combustion chamber 18 by contact of the valve sleeve 36 with combustion seals 36a and 36b until the chamber switch 44 is activated. This operation also induces a measured amount of fuel to be released into the combustion chamber 18 from a fuel canister 50 (shown in fragment).

Upon a pulling of the trigger 26, the spark plug 46 is energized, igniting the fuel and air mixture in the combustion chamber 18 and sending the piston 22 and the driver blade 24 downward toward the waiting fastener. As the piston 22 travels down the cylinder, it pushes a rush of air which is exhausted through at least one petal or check valve 52 (FIG. 2) and at least one vent hole 53 is located beyond piston displacement as is known in the art. At the bottom of the piston stroke or the maximum piston travel distance, the piston 22 impacts a resilient bumper 54. With the piston 22 beyond the exhaust check valve 52, high pressure gasses vent from the cylinder 20. Due to internal pressure differentials in the cylinder 20, the piston 22 is drawn back to the pre-firing position shown in FIG. 3.

To ensure that the piston 22 returns to the prefiring position of FIG. 3 even during relatively rapid rate repetitive firing, the present tool 10 preferably incorporates a lockout device, generally designated 60 and configured for preventing the reciprocation of the valve sleeve 36 from the closed or firing position, to the rest position, until the piston 22 returns to the pre-firing position. This holding or locking function of the lockout device 60 is operational for a specified period of time required for the piston 22 to return to the pre-firing position. Thus, the operator using the tool 10 in a repetitive cycle mode can lift the tool from the workpiece where a fastener was just driven, and begin to reposition the tool for the next firing cycle. With the present lockout device 60, the piston 22 return and the controlled opening of the combustion chamber 18 can occur while the tool 10 is being moved toward the next workpiece location.

More specifically, and while other types of lockout devices are contemplated and are disclosed in the co-pending application No. 11/028,432 incorporated by reference, the exemplary lockout device 60 includes an electromagnet 62 configured for engaging a sliding cam or latch 64 which transversely reciprocates relative to valve sleeve 36 for preventing the movement of the valve sleeve 36 for a specified amount of time. This time period is controlled by a control system 66 (FIG. 1) incorporating a program, or circuit 66a, typically a microprocessor, and embodied in a central processing unit or control module 67 (shown hidden), housed in a handle portion 68 (FIG. 1) or other location in the housing 12, as is well known in the art. While other orientations are contemplated, in the depicted embodiment, the electromagnet 62 is coupled with the sliding latch 64 such that the axis of the electromagnet's coil and the latch is transverse to the driving motion of the tool 10. The lockout device 60 is mounted in operational relationship to an upper portion 70 of the cylinder 20 so that sliding legs or cams 72 of the latch 64 having angled ends 74 pass through apertures 76 in a mounting bracket 78 and the housing 12 to engage a recess or shoulder 80 in the valve sleeve 36 once it has reached the firing position. The latch 64 is biased to the locked position by a spring 82 and is retained by the electromagnet 62 for a specified time interval.

For the proper operation of the lockout device 60, the control program 66a is configured so that the electromagnet 62 is energized for the proper period of time to allow the piston 22 to return to the pre-firing position subsequent to firing. More specifically, when the control program 66a, triggered by an operational sequence of switches (not shown) indicates that conditions are satisfactory to deliver a spark to the combustion chamber 18, the electromagnet 62 is energized by the control program 66a for approximately 100 msec. During this event, the latch 64 is held in position, thereby preventing the chamber 18 from opening. The period of time of energization of the electromagnet 62 would be such that enough dwell is provided to satisfy all operating conditions for full piston return. This period may vary to suit the application.

The control program 66a is configured so that once the piston 22 has returned to the pre-firing position; the electromagnet 62 is de-energized and via sliding latch 64, the spring 38 will overcome the force of the spring 82, and any residual force of the electromagnet 62, and will cause the valve sleeve 36 to move to the rest or extended position, opening up the combustion chamber 18 and the gaps 40U, 40L. This movement is facilitated by the shoulder 80 of the valve sleeve 36 acting on the cammed surfaces 74 of the legs 72, thereby retracting the sliding latch 64. As is known, the valve sleeve 36 must be moved away from the fan 48 to open the chamber 18 for exchanging gases in the combustion chamber and preparing for the next combustion. A suitable alternative lockout device is described in copending U.S. application Ser. No. ______ Filed concurrently herewith entitled: COMBUSTION CHAMBER CONTROL FOR COMBUSTION-POWERED FASTENER-DRIVING TOOL (15320/0901.74331) which is incorporated by reference.

As is known, the control program 66a is operable in either a sequential or a repetitive cycle operating system, and the details of such a system are disclosed in commonly assigned U.S. application Ser. No. 11/028,450, published as US Patent Application No. 2005/0173487A1 which is incorporated by reference. In summary, in sequential operation, as described above, the chamber switch 44 must be closed by upward movement of the valve sleeve 38 to the valve sleeve prefiring position shown in FIG. 3 before the trigger 26 can be pulled to initiate combustion. In repetitive cycle operation, the user maintains the trigger 26 pulled during tool operation, and each subsequent ignition is initiated by the closing of the chamber switch 44, with every tool actuation against the workpiece.

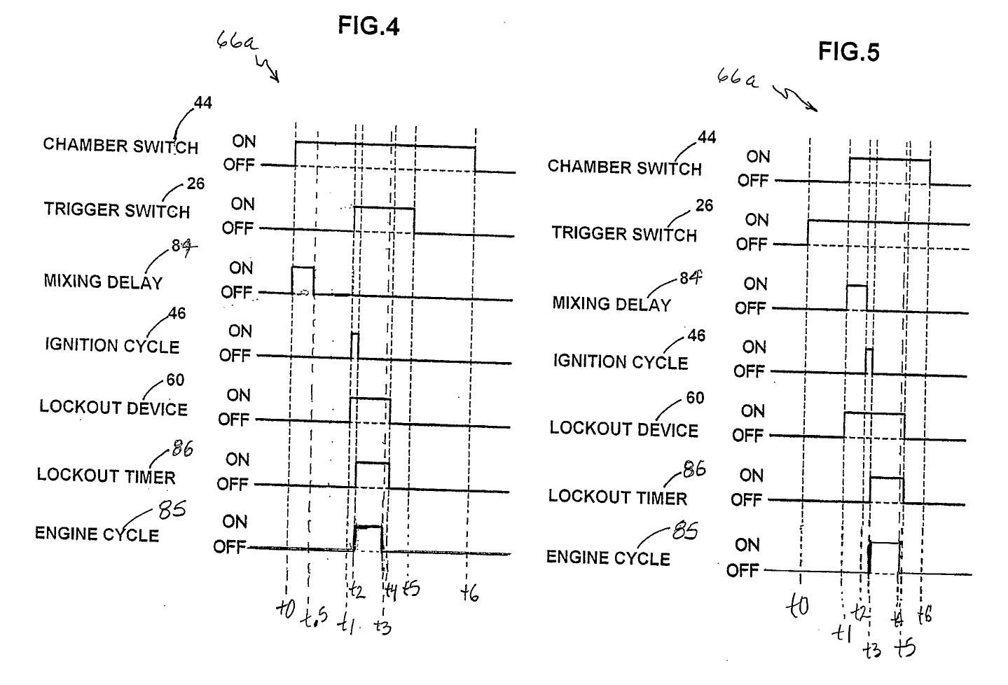

Referring now to FIG. 4, the present control program 66a features a configuration for activating the lockout device 60 in a first format when in the sequential firing mode, and in a second format when in the repetitive firing mode. FIG. 4 depicts the present control program 66a in the sequential firing mode. FIGS. 4 and 5 are depicted as timing charts, in which the relative sequence of tool cycle events are depicted. It will be understood that the duration of the particular events may vary to suit the particular tool or the particular operational situation. Also, it will be understood that the sequence of the events depicted in FIGS. 4 and 5 is under the control of the module 67, more specifically the control program 66a. However, it is contemplated that other control programs may be suitable with discrete components connected by conventional circuits.

At t0, the chamber or head switch 44 is closed, which as is known in the art begins fan operation and fuel transmittal to the combustion chamber 18. Also at t0, a mixing delay 84 of a predetermined time begins and allows for movement of the fan 48 to completely mix the fuel and air. The mixing delay 84 is preferably a clock feature programmed into the control program 66a. A preferred mixing delay period is in the range of 30-50 msec and expires at t.5.

At t1, after the completion of the mixing delay, the trigger 26 is pulled or closed, which initiates the ignition cycle 46 within the control module 67, and creates a spark at spark plug 46. This ignites the fuel/air mixture in the combustion chamber 18, driving the piston 22 and the driver blade 24 down the cylinder 20 for driving a fastener. As is seen in FIG. 4, the ignition cycle is momentary. Simultaneously with the pulling of the trigger switch 26, the ignition cycle 46 is activated at t1, and the lockout device 60 is energized, which retains the valve sleeve 36 in the closed position. Thus, in the sequential firing mode, the lockout device 60 is energized upon the activation of the trigger switch 26 following the expiration of the designated mixing delay 84

At t2, a lockout timer 86 is initiated to allow for completion of the engine cycle 85, at t2-t3, before releasing the lockout device at t4. This interval is preferably in the range of 75-125 msec, but this interval, while predetermined, may vary to suit the situation. As is the case with the mixing delay 84, the lockout timer 86 is a clock function of the control program 66a or other operational circuit.

Next, at t4, the lockout timer 86 expires, releasing the lockout device 60. At t5, the trigger 26 is released, and at t6, the chamber switch 44 is released, allowing the combustion chamber 18 to be vented and recharged with air for the next combustion.

Referring now to FIG. 5, the sequence of events is depicted when the tool 10 is in the repetitive cycle mode. After the user selects the repetitive cycle mode, such as described in patent application U.S. application Ser. No. 11/028,450, published as US Patent Application No. 2005/0173487A1 which is incorporated by reference, at t0, the trigger 26 is pulled, which does not initiate ignition at this time since the chamber switch 44 is not closed. At t1, the chamber switch 44 is closed, the mixing delay 84 is initiated and the lockout device 60 is energized to effectively retain the valve sleeve 36 in position. Next, at t2, at the expiration of the mixing delay 84, the ignition cycle 46 is initiated and the spark plug 46 is energized. As in the case of FIG. 4, the lockout timer 86 is initiated at t3 at the expiration of both the mixing delay and spark plug energization. Also at t3, the engine cycle begins, and continues to t4. Again, at t5, after conclusion of the engine cycle the lockout timer 86 expires, releasing the lockout device 60. It is contemplated that the duration of the lockout timer 86 will be the same whether the tool 10 is in the repetitive or sequential modes. Lastly, at t6, the chamber switch 44 is opened, allowing the combustion chamber 18 to vent and be recharged. It will be seen that there is no release point shown for the trigger switch 26, since the tool 10 is in repetitive cycle mode, the trigger is held until operation is terminated.

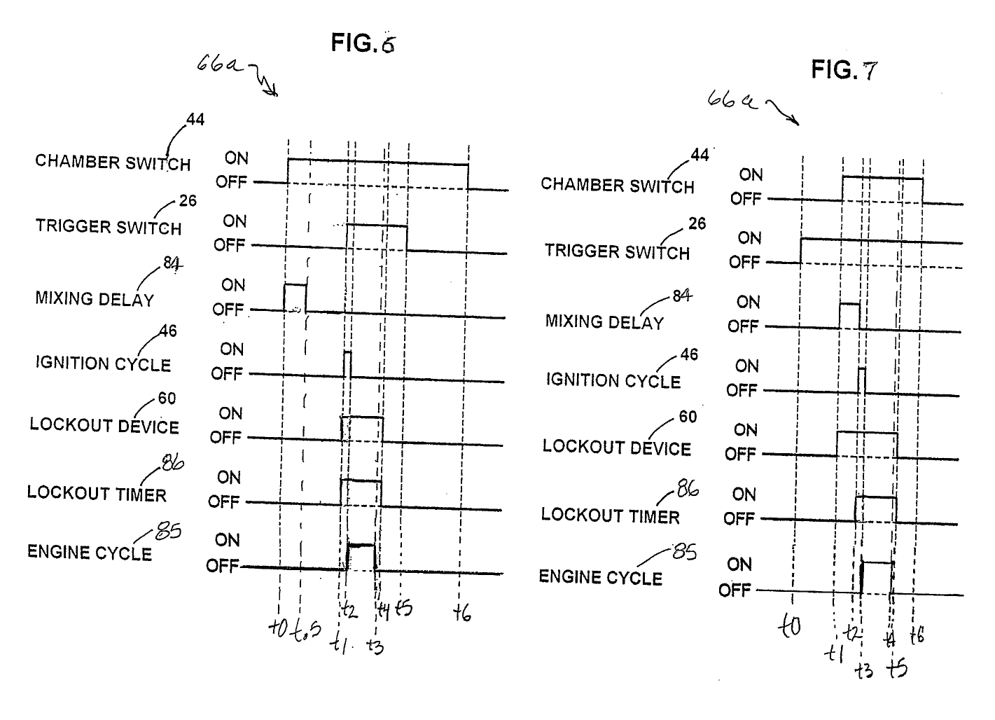

Referring now to FIGS. 6 and 7, alternate embodiments of the control programs of FIGS. 4 and 5 respectively are shown. The difference in the alternate embodiments is that the lockout timer 80 begins at t1 at the initiation of the ignition cycle 46 rather than at the completion of the ignition cycle. It will be appreciated that these programming options may alternately be incorporated into either of the systems disclosed in FIGS. 4 and 5.

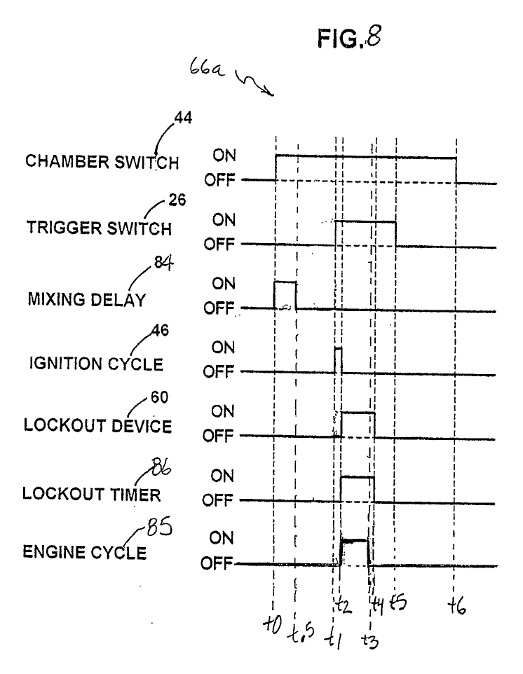

Referring now to FIG. 8, a still further alternate embodiment is depicted, which is a variation of the program of FIG. 4, in which all the steps are the same except the lockout device 60 is energized at t2 after the completion of the mixing delay 84 at t.5 and subsequent to activation of the trigger switch 26 at t1. It will be appreciated that this programming option may alternately be incorporated into either of the embodiments of systems disclosed in FIGS. 4 and 6.

Thus it will be seen that the present combustion nailer control program with selectable firing modes provides an electromechanical lockout device 60 that is sensitive to firing mode. An advantage of the present system is that positive engagement of the lockout device with the valve sleeve is facilitated regardless of the firing mode of the nailer, but particularly during the repetitive firing mode. In addition, tool power consumption is reduced during sequential operation.

While a particular embodiment of the present selectable firing mode with electromechanical lockout for a combustion-powered fastener-driving tool has been described herein, it will be appreciated by those skilled in the art that changes and modifications may be made thereto without departing from the invention in its broader aspects and as set forth in the following claims.

1. A combustion-powered fastener-driving tool, comprising:
a power source including a cylinder and a valve sleeve reciprocating relative to said cylinder between a closed position defining and closing a combustion chamber, and an open position allowing venting of said combustion chamber;
a lockout device associated with said power source and configured for releasably restraining said valve sleeve in said closed position; and
a control system connected to said power source and operable in both a sequential firing mode and a repetitive firing mode, and being configured for activating said lockout device in a first format when in said sequential firing mode, and in a second format when in said repetitive firing mode.

2. The tool of claim 1, wherein said control system is configured so that, when in said sequential firing mode, said lockout device is energized upon activation of a trigger switch.

3. The tool of claim 2, wherein said control system further includes a lockout timer for controlling the amount of time said lockout device is energized, said lockout timer being energized at completion of said ignition cycle and continuing energization of said lockout device for a designated time.

4. The tool of claim 2, wherein said control system further includes a lockout timer for controlling the amount of time said lockout device is energized, said lockout timer being energized at initiation of said ignition cycle and continuing energization of said lockout device for a designated time.

5. The tool of claim 1, wherein said control system is configured so that, when in said sequential firing mode, said lockout device is energized upon initiation of an ignition cycle.

6. The tool of claim 1, wherein said control system is configured so that, when in said sequential firing mode, said lockout device is energized upon the completion of an ignition cycle.

7. The tool of claim 1, wherein said control system is configured so that, when in said sequential firing mode, said lockout device is energized upon the expiration of a designated mixing delay and trigger switch activation.

8. The tool of claim 1, wherein said control system is configured so that, when in said repetitive firing mode, said lockout device is energized upon closing of a chamber switch, indicating that said combustion chamber is closed.

9. The tool of claim 8, wherein said control system further includes a lockout timer for controlling the amount of time said lockout device is energized, said lockout timer being energized upon completion of an ignition cycle and continuing energization of said lockout device for a designated time.

10. The tool of claim 8, wherein said control system further includes a lockout timer for controlling the amount of time said lockout device is energized, said lockout timer being energized at said initiation of an ignition cycle and continuing energization of said lockout device for a designated time.

11. The tool of claim 8, wherein said control system further includes a mixing delay timer for delaying initiation of an ignition cycle for a designated time after said closing of said chamber switch.

12. A combustion-powered fastener-driving tool, comprising:
a power source including a cylinder and a valve sleeve reciprocating relative to said cylinder between a closed position defining and closing a combustion chamber, and an open position allowing venting of said combustion chamber;
a piston with a driver blade reciprocating in said cylinder;
a spark generator for initiating ignition of gas in said combustion chamber for driving said piston in said cylinder;
a chamber switch associated with said power source and is closed when said valve sleeve is positioned to create said closed combustion chamber;
a lockout device associated with said power source and configured for releasably restraining said valve sleeve in said closed position; and
a control system connected to said power source and operable in both a sequential firing mode and a repetitive firing mode, and being configured for activating said lockout device upon activation of said trigger switch when in said sequential firing mode, and upon closing of said chamber switch when in said repetitive firing mode.

13. The tool of claim 12, wherein said control system further includes a lockout timer for controlling the amount of time said lockout device is energized, said lockout timer being energized upon said initiation of said ignition cycle and continuing energization of said lockout device for a designated time, regardless of said tool being in said sequential operational mode or in said repetitive cycle mode.

14. The tool of claim 12, wherein said control system further includes a lockout timer for controlling the amount of time said lockout device is energized, said lockout timer being energized upon said completion of said ignition cycle and continuing energization of said lockout device for a designated time, regardless of said tool being in said sequential operational mode, or in said repetitive cycle mode.
